(19) United States
(12) Patent Application Publication
(10) Pub. No.: US 2008/0088826 A1
(43) Pub. Date: Apr. 17, 2008

(54) Target detection apparatus

(75) Inventors: Tatsushi Ohyama, Ogaki-city (JP); Keisuke Watanabe, Mizuho-city (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD

(21) Appl. No.: 11/905,649

(22) Filed: Oct. 3, 2007

(30) Foreign Application Priority Data
Oct. 16, 2006 (JP) 2006-282019

(51) Int. Cl. G01J 3/00

(52) U.S. Cl. 356/51

(57) ABSTRACT

A target detection apparatus detects a target object from within an image by utilizing reflection characteristics in both a visible light range and an infrared light range of the target object. Image pickup devices output a plurality of mutually different color components and an infrared light component from incident light. A control unit generates hue components for respective regions from the plurality of color components and determines whether the regions represent a target object or not by using the hue components and the infrared light component in the regions. Alternatively, the control unit performs a predetermined computation between each of at least two kinds of color components and an infrared light component and determines whether a region corresponding to the computed components represents a target object, according to the computation result.

### CROSS-REFERENCE TO RELATED APPLICATIONS

This application is based upon and claims the benefit of priority from the prior Japanese Patent Application No. 2006-282019, filed on Oct. 16, 2006, the entire contents of which are incorporated herein by reference.

### BACKGROUND OF THE INVENTION

1. Field of the Invention

The present invention relates to a target detection apparatus for detecting a target object such as a person.

2. Description of the Related Art

Monitoring cameras for security applications and in-vehicle cameras capable of assisting a driver in his or her driving performance by capturing images around a vehicle have come into wide use in recent years. It is desirable that the cameras for such uses be provided with a function for recognizing an object to be detected, such as a person, separately from the background.

### SUMMARY OF THE INVENTION

A target detection apparatus according to one embodiment of the present invention is an apparatus which detects a target object from within a captured image. This apparatus detects the target object from within the image by utilizing reflection characteristics in both a visible light range and an infrared light range of the target object.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 shows a basic structure of a target detection apparatus according to an embodiment of the present invention;

FIG. 2 shows a structure of a control unit according to a second embodiment of the present invention;

FIG. 3 is two-dimensional coordinates showing parameters used in detecting a target object in a second embodiment of the present invention;

FIG. 4A to 4C illustrate processes by which a person is detected from within an image by a target detection processing according to a second embodiment of the present invention;

FIG. 5 shows a structure of a control unit according to a third embodiment of the present invention;

FIGS. 6A to 6C illustrate processes for detecting a person from within an image by a target detection processing according to a third embodiment of the present invention;

FIG. 7 is a flowchart explaining an operation of a target detection apparatus according to a third embodiment of the present invention;

FIG. 8 is two-dimensional coordinates showing parameters used in detecting a target object in a fourth embodiment of the present invention; and

FIG. 9 is a flowchart explaining an operation of a target detection apparatus according to a fourth embodiment of the present invention.

### DETAILED DESCRIPTION OF THE INVENTION

The invention will now be described by reference to the preferred embodiments. This does not intend to limit the scope of the present invention, but to exemplify the invention.

Firstly, a description of a representative embodiment will be given before describing preferred embodiments of the present invention. A target detection apparatus according to one embodiment of the present invention is an apparatus which detects a target object from within a captured image by utilizing reflection characteristics in both a visible light range and an infrared-light range of the target object.

According to this embodiment, the detection accuracy can be enhanced because both visible light components and infrared light components are utilized in the detection of a target object.

Another embodiment of the present invention relates also to a target detection apparatus. This target detection apparatus is an apparatus which detects a target object from within a captured image, and this apparatus includes: an image pickup device which outputs a plurality of different color components and an infrared light component from incident light; and a control unit which generates hue components for respective regions from the plurality of color components and which determines whether the regions represent a target object or not by using the hue components and the infrared light component in the regions. The “region” herein may be a single pixel, a set of a plurality of pixels, or a whole screen.

Still another embodiment of the present invention relates also to a target detection apparatus. This apparatus is an apparatus which detects a target object from within a captured image, and this apparatus includes: an image pickup device which outputs a plurality of mutually different color components and an infrared light component from incident light; and a control unit which performs a predetermined computation between each of at least two kinds of color components and an infrared light component and which determines whether a region corresponding to the computed components represents a target object by referring to a computation result. The “computation” herein may be a division or a subtraction.

According to this embodiment, the ratio between color component and infrared light component, the difference therebetween, and the like are used in determining a region representing a target object, so that the detection accuracy can be enhanced because the decision takes into account the reflection characteristics in both the visible light range and infrared light range.

The control unit may perform a plurality of mutually different computations between each of at least two color components and an infrared light component and may determine that the region corresponding to the computed components is a region representing the target object if each of results of all the computations fall within each of ranges of respective preset values. In this arrangement, the detection accuracy can be further enhanced by combining a plurality of detection methods.

The image pickup device may output a red component, a green component and a blue component from entering light, and the control unit may calculate a red subtraction value, which is obtained by subtracting the value of the red component multiplied by a first predetermined coefficient from the infrared light component, a green subtraction value, which is obtained by subtracting the value of the green component multiplied by a second predetermined coefficient from the infrared light component, and a blue subtraction value, which is obtained by subtracting the value of the blue component multiplied by a third predetermined coefficient from the infrared light component and may determine whether the pixel represents a target object or not, using two values out of the red subtraction value, the green subtraction value and the blue subtraction value, or the difference therebetween. The “first predetermined coefficient” by which a red component is multiplied may be generated based on a ratio between an average of infrared light components within an image and an average of red components within an image. The “second predetermined coefficient” by which a green component is multiplied may be generated based on a ratio between an average of infrared light components within an image and an average of green components within an image. The “third predetermined coefficient” by which a blue component is multiplied may be generated based on a ratio between an average of infrared light components within an image and an average of blue components within an image.

Still another embodiment of the present invention relates to a method of detecting a target object. This method is a method for detecting a target object from within a captured image, wherein the target object is detected from within the captured image by utilizing reflection characteristics in both a visible light range and an infrared light range of the target object.

According to this embodiment, the detection accuracy can be enhanced because both visible light components and infrared light component are utilized in the detection of a target object.

It is to be noted that any arbitrary combination of the above-described structural components and the expressions according to the present invention changed among a method, an apparatus, a system and so forth are all effective as and encompassed by the present embodiments.

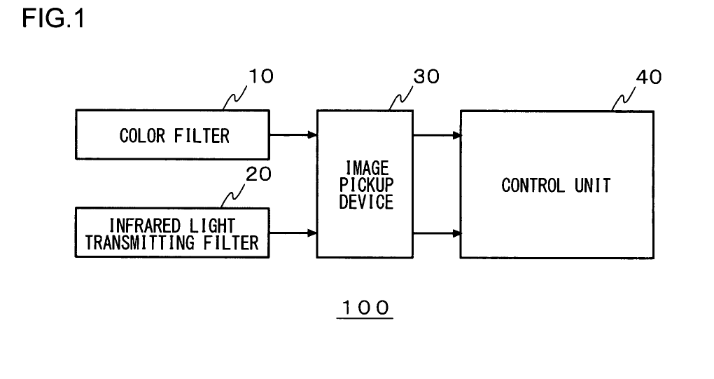

FIG. 1 shows a basic structure of a target detection apparatus 100 according to an embodiment of the present invention. The target detection apparatus 100 includes a color filter 10, an infrared light transmitting filter 20, an image pickup device 30, and a control unit 40. The color filter 10 breaks up incident light into a plurality of colors and supplies them to the image pickup devices 30. When the color filter 10 is to be constructed by a three-primary-color filter, three types of filters, namely, a filter for transmitting red R, a filter for transmitting green G and a filter for transmitting blue B, may be used in a Bayer arrangement, for instance.

When the color filter 10 is to be constructed by a complementary filter, incident light may be broken up into yellow (Ye), cyan (Cy), and magenta (Mg). Alternatively, it may be broken up into yellow (Ye), cyan (Cy) and green (Gr) or into yellow (Ye), cyan (Cy), magenta (Mg) and green (Gr). The color filter 10, which is not provided with an infrared cut filter, also transmits infrared light components in addition to visible light components.

The infrared light transmitting filter 20 transmits infrared light components and supplies them to the image pickup devices 30. The image pickup device 30 is constructed by a CCD (Charge Coupled Device) image sensor or a CMOS (Complementary Metal-Oxide Semiconductor) image sensor. A sheet of image sensor may be provided for each color, and an image of each color may be combined. Or a color image may be generated by receiving incident light from the color filter 10 in a Bayer arrangement and performing an interpolation operation using the output of surrounding pixels.

The image pickup device 30 has not only a region that receives a plurality of color components transmitted through the color filter 10 but also a region that receives infrared light components transmitted through the infrared light transmitting filter 20. The number of regions for receiving color components is proportional to the number of regions for receiving infrared light components. In a Bayer arrangement, for example, the minimum unit includes two elements for receiving green G, and one of them may be used as the element for receiving infrared light. In this case, the minimum unit of the Bayer arrangement includes one each of element for receiving red R, green G, blue B and infrared IR.

The image pickup device 30 supplies an image signal of multiple colors generated through a photoelectric conversion of received color components and a signal generated through a photoelectric conversion of received infrared components (hereinafter denoted as “IR signal”) to the control unit 40.

A description will now be given of a first embodiment of the present invention based on the structure as described above. In the following description, note that a person is assumed as a target object to be detected. In the detection of a person from within an image, reflection characteristics in both the visible light range and infrared light range of the human skin are utilized.

A control unit 40 according to the first embodiment receives a signal having undergone a photoelectric conversion at an image pickup device 30 after passing through a red R-transmitting filter (hereinafter referred to as “R signal”), a signal having undergone a photoelectric conversion at the image pickup device 30 after passing through a green G-transmitting filter (hereinafter referred to as “G signal”), a signal having undergone a photoelectric conversion at the image pickup device 30 after passing through a blue B-transmitting filter (hereinafter referred to as “B signal”), and an IR signal from the image pickup device 30 and performs the following arithmetic operations on those signals.

In other words, the ratios of the R signal, the G signal and the B signal, respectively, to the IR signal are calculated as values showing the relation of the R signal, the G signal and the B signal, respectively, to the IR signal. More concretely, R/IR, G/IR and B/IR are calculated. The control unit 40 carries out these operations on each pixel. The control unit 40 determines for each pixel whether the three kinds of values, namely, R/IR, G/IR and B/IR, fall within their respectively predetermined ranges, and determines the pixel to be a region corresponding to the human skin if all the values of R/IR, G/IR and B/IR fall within their respectively predetermined ranges. It may also be appreciated that the above decision can be made using two values out of R/IR, G/IR and B/IR. The ranges to be set for the respective colors may be determined by a designer experimentally or through simulation. In this embodiment, they are set based on the color components and the infrared component of the human skin.

By making above decisions for all the pixels, the control unit 40 can identify a region within an image where the human skin has been detected. Note that the differences of the R signal, the G signal and the B signal, respectively, from the IR signal may also be used as the values showing their relations with the IR signal. For example, R-IR, G-IR, and B-IR may be used. In this case, too, the pixels supposed to represent part of a target object are extracted by determining whether the values fall within their respectively predetermined ranges. Also, it should be appreciated that the values showing the relations of the R signal, the G signal and the B signal, respectively, with the IR signal are not limited to the above-described ratios or differences but they may be values after certain arithmetic operations such as multiplication or addition thereof.

As hereinbefore described, according to the first embodiment, the detection of a target object from within an image is carried out by determining whether or not the values showing the relations of the color components and the infrared component of the target object represent the target object. Thus the detection accuracy can be enhanced. For example, if an object has a skin color but absorbs all the infrared lights or has low reflectance in the infrared light range, such an object can be easily distinguished from the human skin that has high reflectance in the infrared light range.

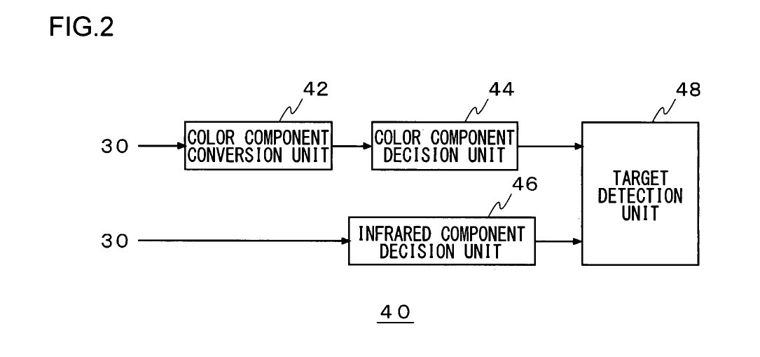

Next, a description will be given of a second embodiment of the present invention. FIG. 2 shows a structure of a control unit 40 according to the second embodiment. The control unit 40 according to the second embodiment includes a color component conversion unit 42, a color component decision unit 44, an infrared component decision unit 46, and a target detection unit 48. In terms of hardware, the structure of the control unit 40 can be realized by any DSP, memory and other LSIs. In terms of software, it can be realized by memory-loaded programs and the like, but drawn and described herein are function blocks that are realized in cooperation with those. Hence, it is understood by those skilled in the art that these function blocks can be realized in a variety of forms such as by hardware only, software only or the combination thereof.

The color component conversion unit 42 converts a color space defined by RGB supplied by an image pickup device 30 into a color space defined by HSV. Here, H represents hue, or the color type; S saturation, or the intensity of the color; and V a value, or the brightness of the color. The hue defines the types of color in a range of 0 to 360 degrees. The conversion of RGB space into HSV space can be effected using the generally-known conversion equations.

The color component decision unit 44 determines whether a hue derived by a conversion at the color component conversion unit 42 falls within a range of hues predetermined for the decision of a target object. For example, a range of 1 to 30 degrees is set as the range of hues for the decision of the human skin. The infrared component decision unit 46 determines whether an infrared component derived from an image pickup device 30 falls within a range of infrared light components predetermined for the decision of a target object. The color component decision unit 44 and the infrared component decision unit 46 deliver their respective results of decision to the target detection unit 48. Note that the above ranges of hues and infrared light components that are to be predetermined may be set by a designer experimentally or through simulation. The designer can adjust those ranges according to the type of target object.

The target detection unit 48 determines whether the applicable pixels are pixels representing a target object, based on the results of decision derived from the color component decision unit 44 and the infrared component decision unit 46.

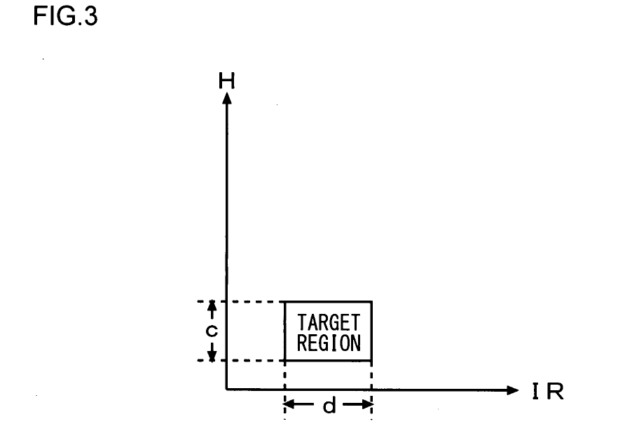

FIG. 3 is two-dimensional coordinates showing the parameters used in detecting a target object in the second embodiment. In FIG. 3, the parameters used in detecting a target object are the hue H and the infrared light component IR.

The target detection unit 48 determines whether the applicable pixels lies within a target region on the two-dimensional coordinates as shown in FIG. 3. More concretely, the target detection unit 48 determines that the applicable pixels are pixels representing a target object if the hue thereof lies within a predetermined range c of the hue H and besides the infrared light component thereof lies within a predetermined range d of the infrared light component IR. Otherwise, the pixels in question are not determined to be those representing a target object. For example, even if the hue of the pixels in question is within a range of 1 to 30 degrees and the object is assumed to be skin-colored or brownish-red, the object is determined to be something other than the human skin if the infrared light component of the pixels in question is outside the range of infrared light components predetermined for the human skin.

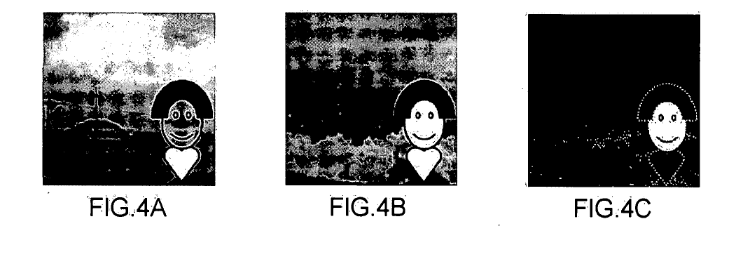

FIG. 4A to 4C illustrate processes by which a person is detected from within an image by a target detection processing according to the second embodiment. FIG. 4A shows an image synthesized from R signals, G signals and B signals derived from image pickup devices 30. Since the color filter 10 also transmits infrared light components, the R signals, G signals and B signals contain infrared light components also. Hence, the image shown in FIG. 4A contains infrared light components as well. FIG. 4B shows an image synthesized from IR signals from image pickup devices 30. The human skin, which has a high reflectance in the infrared light range, is shown white. The leaves and branches of trees, which have also high reflectances in the infrared light range, are shown white, too. The pixels in the regions with lower reflectances in the infrared light range are shown dark. FIG. 4C is a binary image of white which is the pixels determined to lie in the target region by the target detection unit 48 and black which is the other pixels. The image of FIG. 4C shows the human skin emerging white. The other white parts are noise portions and the edge lines of the person against the background. The edge portions also have higher infrared reflectances. Note that if a noise canceller is used, the person only can be shown popping up.

As hereinbefore described, according to the second embodiment, the accuracy of detection of a target object from within an image can be enhanced by performing the decision of the infrared component of the target object in addition to the decision of the color components thereof. Also, the determination of color components after hue conversion makes it possible to detect the human skin using the same preset value whether the person belongs to the yellow-skinned race, the white-skinned race or the black-skinned race. In this respect, if the human skin is to be recognized in the RGB space, the preset values must be changed according to the yellow-skinned race, the white-skinned race and the black-skinned race.

Next, a description will be given of a third embodiment of the present invention. In the third embodiment, IR-αR, IR-βG, and IR-γB are calculated as values showing the relation of the R signal, the G signal and the B signal, respectively, to the IR signal, and a target object is detected based on those differences. The method of calculating the coefficient α, the coefficient β and the coefficient γ will be discussed later.

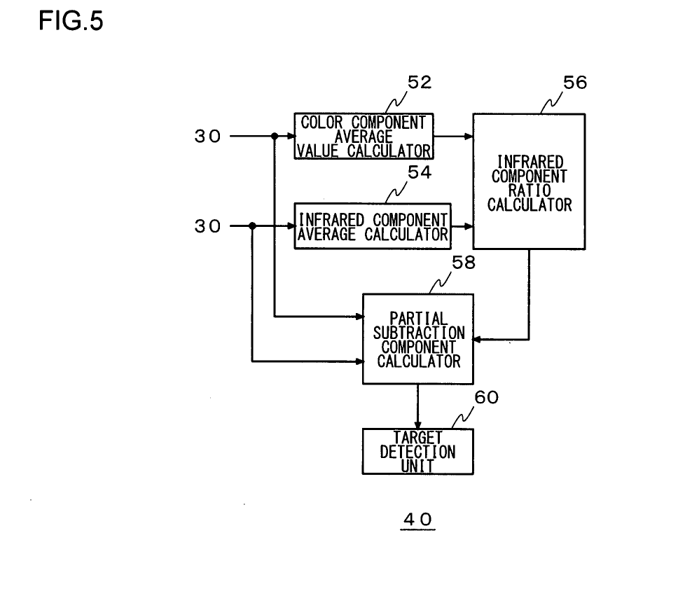

FIG. 5 shows a structure of a control unit 40 according to the third embodiment. The control unit 40 according to the third embodiment includes a color component average calculator 52, an infrared component average calculator 54, an infrared component ratio calculator 56, a partial subtraction component calculator 58, and a target detection unit 60.

The color component average calculator 52 calculates the average values of the R signal, the G signal and the B signal, respectively. That is, an average R signal Ravg can be generated by adding up R signals, one from each pixel, for all the pixels and then dividing the sum by the number of all the pixels. The same is applied to the G signal and the B signal as well. Since the R signal, the G signal and the B signal contain their respective infrared light components, the average R signal Ravg, the average G signal Gavg and the average B signal Bavg contain their respective infrared light components also. Note that in an alternative arrangement, an image may be divided into a plurality of blocks and an average R signal Ravg, an average G signal Gavg and an average B signal Bavg may be generated for each block.

The infrared component average calculator 54 calculates the average value of IR signals. That is, an average IR signal IRavg can be generated by adding up IR signals, one from each pixel, for all the pixels and then dividing the sum by the number of all the pixels. Note that in an alternative arrangement, an image may be divided into a plurality of blocks and an average IR signal IRavg may be generated for each block.

The infrared component ratio calculator 56 calculates the ratios of the average R signal Ravg, the average G signal Gavg and the average B signal Bavg, respectively, to the average IR signal IRavg. Then the infrared ratio calculator 56 corrects the calculated ratios. Such corrections will be discussed in detail later.

The partial subtraction component calculator 58 calculates, for each pixel, a partial subtraction component Sub_r, which is obtained as follows. That is, the value of an R signal multiplied by a ratio which is obtained, after the above-described correction, as a coefficient α is subtracted from an IR signal. At this time, the calculated value is substituted by zero if it is negative. The same procedure as with the R signal is taken for the G signal and the B signal as well.

The target detection unit 60 generates an image for target detection by plotting values which are obtained by subtracting a partial subtraction component Sub_r of an R signal from a partial subtraction component Sub_b of a B signal for each pixel. At this time, the calculated value is substituted by zero if it is negative.

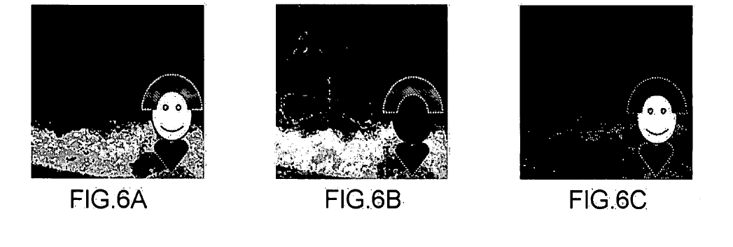

FIGS. 6A to 6C illustrate the processes for detecting a person from within an image by a target detection processing according to the third embodiment. The images in FIGS. 6A to 6C represent the same scene as in FIGS. 4A to 4C. Therefore, the color image generated and synthesized from R signals, G signals and B signals and the infrared image, which are the same as FIG. 4A and FIG. 4B, are not shown here.

FIG. 6A is an image generated by plotting the partial subtraction component Sub_b of B signals. This image is presented in grayscale. The larger the IR signal, the greater the value of Sub_b of the B signal will be. The smaller the R signal, the greater the value of Sub_b of the R signal will be. Also note that the color used is closer to white for the greater values and closer to black for the smaller values. The human skin has high reflectance in the infrared light components and medium reflectance in the blue wavelengths, and therefore the partial subtraction component Sub_b of the B signals is large. Similarly, the leaves of trees have high reflectance in the infrared light components and medium reflectance in the blue wavelengths, and therefore the partial subtraction component Sub_b of the B signals is also large. As a result, the human skin and the leaves of trees come out white as shown in FIG. 6A.

FIG. 6B is an image generated by plotting the partial subtraction component Sub_r of R signals. This image is also presented in grayscale. The larger the IR signal, the greater the value of Sub_r of the R signal will be. The smaller the R signal, the greater the value of Sub_r of the R signal will be. As with the partial subtraction component Sub_b of B signals, the color used is closer to white for the greater values and closer to black for the smaller values. The human skin has high reflectance in the infrared light components and also high reflectance in the red wavelengths, and therefore the partial subtraction component Sub_r of the R signals is not particularly large. On the other hand, the leaves of trees have high reflectance in the infrared light components and zero or extremely low reflectance in the red wavelengths, and therefore the partial subtraction component Sub_r of the R signals is conspicuously large. As a result, the leaves of trees only come out white as shown in FIG. 6B.

FIG. 6C is an image generated by plotting the values obtained by subtracting the partial subtraction component Sub_r of the R signal from the partial subtraction component Sub_b of the B signal. This image is also presented in grayscale. As described above, the leaves of trees have the partial subtraction component Sub_r of the R signal larger than or equal to the partial subtraction component Sub_b of the B signal. Thus the subtraction of the partial subtraction component Sub_r of the R signal from the partial subtraction component Sub_b of the B signal results in a negative value or a zero. In the case of a negative value, the value is substituted by a zero, and as a result, the regions of the leaves of trees become black. On the other hand, the human skin has the partial subtraction component Sub_b of the B signal larger than the partial subtraction component Sub_r of the R signal, so that the subtraction of the partial subtraction component Sub_r of the R signal from the partial subtraction component Sub_b of the B signal results in a positive value. As a result, the human skin only comes out white as shown in FIG. 6C.

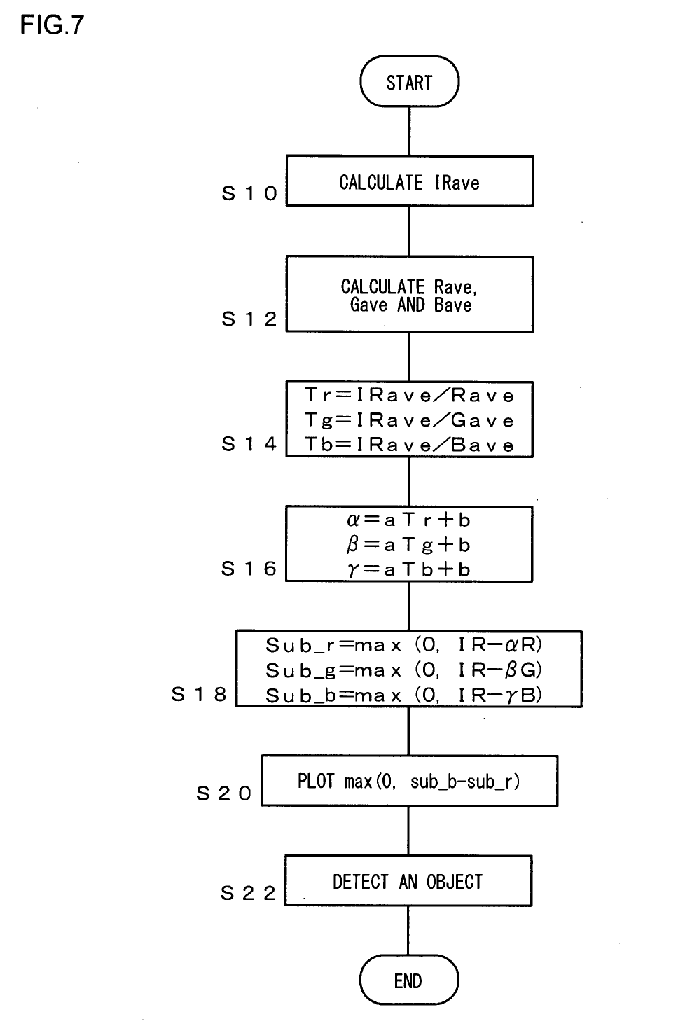

FIG. 7 is a flowchart explaining the operation of a target detection apparatus 100 according to the third embodiment. Firstly, the infrared component average calculator 54 calculates the average value IRave of IR signals (S10), and the color component average calculator 52 calculates the average values Rave, Gave, and Bave of R signals, G signals and B signals, respectively (S12).

Next, the infrared component ratio calculator 56 calculates the ratios Tr, Tg and Tb of the average R signal Ravg, the average G signal Gavg and the average B signal Bavg, respectively, to the average IR signal IRavg (S14). The following equations (1) to (3) are used for the calculation of the ratios Tr, Tg and Tb.

Tr=IRave/Rave Equation (1)

Tg=IRave/Gave Equation (2)

Tr=IRave/Bave Equation (3)

Since the average R signal Ravg, the average G signal Gavg and the average B signal Bavg also contain the infrared light components, the ratios Tr, Tg and Tb show the ratios of the average IR signal IRavg contained in each average R signal Ravg, average G signal Gavg and average B signal Bavg.

The infrared component ratio calculator 56 calculates the correction values of the ratios Tr, Tg and Tb as the coefficient α, the coefficient β and the coefficient γ by which the R signal, the G signal and the B signal are to be multiplied, in a manner such that the calculated ratios Tr, Tg and Tb are each multiplied by a predetermined coefficient and a constant is each added thereto (S16). The following equations (4) to (6) are the general formulas for calculating the coefficient α, the coefficient β and the coefficient γ.

α=aTr+b Equation (4)

β=aTg+b Equation (5)

γ=aTb+b Equation (6)

The coefficient a and the constant b may be any values determined by a designer through experiment or simulation. For example, the coefficient a may be set to 1.2, and the constant b to −0.06. Or the coefficient a and the constant b may be determined by a method of least squares using optimal coefficient α, coefficient β and coefficient γ, and ratios Tr, Tg and Tb derived experimentally or by simulation.

The partial subtraction component calculator 58 performs the calculations of the following equations (7) to (9) for every pixel (S18):

Sub_{—}r=max(0,IR-αR) Equation (7)

Sub_{—}g=max(0,IR-βG) Equation (8)

Sub_{—}b=max(0,IR-γB) Equation (9)

The function max (A, B) used in the above equations (7) to (9) is a function that returns by selecting the larger of A and B. In this embodiment, if the value obtained by subtracting the value of an R signal multiplied by coefficient α from an IR signal is negative, it will be substituted by a zero. The same is applied to a G signal and a B signal as well.

The target detection unit 60 calculates a detection pixel value dp, using the following equation (10), for every pixel and plots the results (S20):

dp=max(0,Sub_{—}b−Sub_{—}r) Equation (10)

The target detection unit 60 detects a target object from within an image that has been generated by plotting the results of computation by the above equation (10) (S22). The target object is extracted based on a scheme that the pixels whose detection pixel value dp is zero or larger or a threshold value or larger are pixels representing a target object. Such a threshold value may be a value predetermined by the designer through experiment or simulation. Also, after the extraction of a target object, a shape recognition may be performed for the region composed of a group of pixels representing the target object. For example, patterns of human faces, hands and the like may be registered in advance, and the above-mentioned region may be checked against such patterns to identify the target object in a more concrete manner.

As hereinbefore described, according to the third embodiment, the accuracy of detection of a target object from within an image can be enhanced because the pixels corresponding to the target object are determined based on values showing a relation between the color components and the infrared component of the target object. Moreover, in this third embodiment, the coefficients by which the values of the color components of each pixel, calculated from the pixels of the whole image and subtracted from the infrared component of each pixel, are multiplied are set to the corrected values of ratios of the average of infrared components calculated from the pixels of the whole image to the averages of the respective color components. Because the average values are used as the basis as described above, it is not necessary to change the parameters for the correction of the above-described ratios even when the brightness or color balance of an image has changed due to a scene change, for instance. The parameters used are such values as to allow optimal detection of a target object, which have been determined through tests and simulations using a variety of images. Hence these parameters already incorporate the differences in brightness and color balance of images.

Next, a description will be given of a fourth embodiment of the present invention. In the fourth embodiment, IR-αR, IR-βG, and IR-γB are calculated as values showing the relation of the R signal, the G signal and the B signal, respectively, to the IR signal, and a target object is detected by determining whether those values fall within predetermined ranges or not.

The structure of a control unit 40 according to the fourth embodiment is the same as that of the third embodiment. The operation of the control unit 40, however, differs therefrom; that is, a partial subtraction calculator 58 and a target detection unit 60 operate differently. A color component average calculator 52, an infrared component average calculator 54 and an infrared component ratio calculator 56 operate the same way as those in the third embodiment, and hence the description thereof is omitted here. In the following, the operation of the partial subtraction calculator 58 and the target detection unit 60 will be explained.

The partial subtraction component calculator 58 calculates, for each pixel, a partial subtraction component Sub_r, which is obtained by subtracting the value of an R signal multiplied by a ratio after the above-described correction as a coefficient α from an IR signal. In the fourth embodiment, the calculated value is used as it is; that is, the value is not substituted by zero even when it is negative. The same applies to the G signal and the B signal as well.

The target detection unit 60 determines whether the partial subtraction components Sub_r, Sub_g, and Sub_b calculated by the partial subtraction component calculator 58 fall within the ranges of partial subtraction components Sub_r, Sub_g and Sub_b having been set in advance for the decision of a target object. Note that the ranges of partial subtraction components Sub_r, Sub_g, and Sub_b to be set in advance may be those determined by the designer through experiment or simulation. The designer may also adjust the ranges according to the target object.

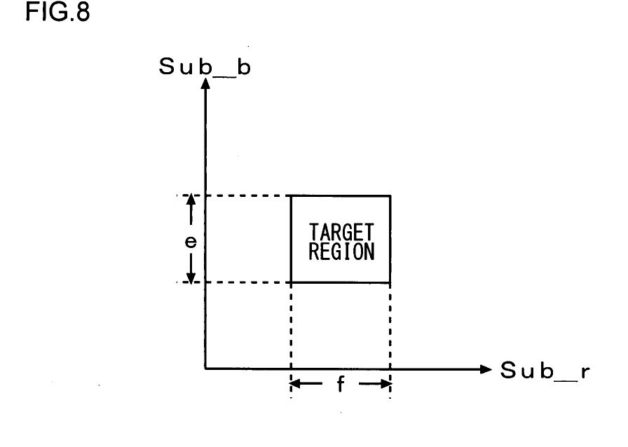

FIG. 8 is two-dimensional coordinates showing the parameters used in detecting a target object in the fourth embodiment. In FIG. 8, the parameters used in detecting the human skin are the partial subtraction component Sub_b of the B signal and the partial subtraction component Sub_r of the R signal.

The target detection unit 48 determines whether the applicable pixels lie within a target region on the two-dimensional coordinates as shown in FIG. 8. More concretely, the target detection unit 48 determines that the applicable pixels are pixels representing a target object if the partial subtraction component Sub_b of the B signal thereof lies within a predetermined range e of the partial subtraction component Sub_b of the B signal and besides the partial subtraction component Sub_r of the R signal thereof lies within a predetermined range f of the partial subtraction component Sub_r of the R signal. Otherwise, the pixels in question are not determined to be those representing a target object.

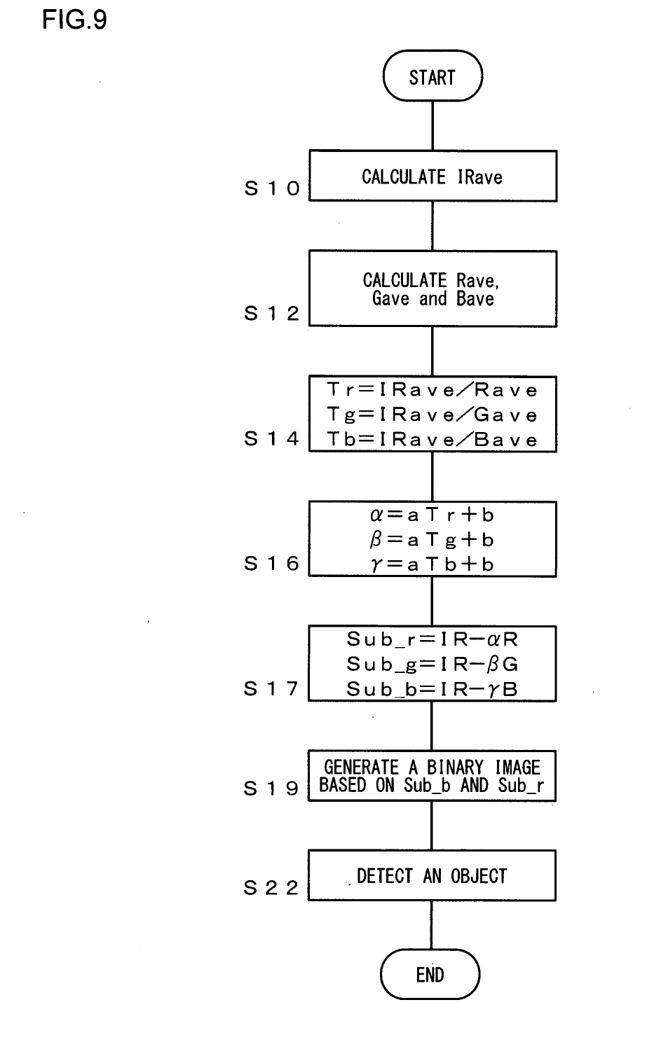

FIG. 9 is a flowchart explaining an operation of a target detection apparatus 100 according to the fourth embodiment. This flowchart is the same as that of the third embodiment as shown in FIG. 7 up to Step 16, so that the description of this part will be omitted here. The following description covers Step 17 and thereafter.

The partial subtraction component calculator 58 calculates the following equations (11) to (13) for every pixel (S17):

Sub_{—}r=IR−αR Equation (11)

Sub_{—}g=IR−βG Equation (12)

Sub_{—}b=IR−γB Equation (13)

Since the fourth embodiment does not use the difference between partial subtraction components Subs themselves, there is no processing of substituting a negative value by a zero as in the third embodiment.

The target detection unit 60 determines whether the partial subtraction component Sub_b of the B signal and the partial subtraction component Sub_r of the R signal of each applicable pixel lie within the target region as shown in FIG. 8. For example, a binary image is generated by plotting the pixel white if those components lie in the target region or black if they do not (S19). The target detection unit 60 detects a target object from within the binary image thus generated (S22).

As hereinbefore described, according to the fourth embodiment also, the accuracy of detection of a target object from within an image can be enhanced because the pixels corresponding to the target object are determined based on the values showing the relation between the color components and the infrared component of the target object.

Next, a description will be given of a fifth embodiment of the present invention. In the fifth embodiment, αIR/R, βIR/G, and γIR/B may preferably be calculated as values showing the relation of the R signal, the G signal and the B signal, respectively, to the IR signal, and a target object is detected by determining whether those values fall within predetermined ranges or not.

The structure of a control unit 40 according to the fifth embodiment is basically the same as that of the third embodiment. However, since the partial ratio components, instead of the partial subtraction components, are calculated in the fifth embodiment, the partial subtraction component calculator 58 must be read as a partial ratio component calculator. The partial ratio component calculator calculates partial ratio components αIR/R, βIR/G, and γIR/B for every pixel. The target detection unit 60 determines for each pixel whether the partial ratio components αIR/R, βIR/G and γIR/B fall within their respectively predetermined ranges, and determines the pixel as one representing a target object if all the values of the partial ratio components αIR/R, βIR/G and γIR/B fall within their respectively predetermined ranges. The ranges to be predetermined for their respective colors may be set by the designer through experiment or simulation. Note also that the above decision may be made not for all but for two of the partial ratio components αIR/R, βIR/G and γIR/B.

As hereinbefore described, according to the fifth embodiment also, the accuracy of detection of a target object from within an image can be enhanced because the pixels corresponding to the target object are determined based on the values showing the relation between the color components and the infrared component of the target object.

Next, a description will be given of a sixth embodiment of the present invention. The sixth embodiment is a combination of two or more of the detection processings as hereinbefore described in the first through fifth embodiments. A success in the detection of a target object is decided when the detection of a target object is successful in all of the plurality of the detection processings employed. A failure in the detection of a target object is decided when the detection of a target object has failed in any of those detection processings. As explained above, according to the sixth embodiment, the detection accuracy can be further enhanced by a combination of a plurality of detection processings.

The present invention has been described based on embodiments. The above-described embodiments are merely exemplary, and it is understood by those skilled in the art that various modifications to the combination of each component and each process thereof are possible and that such modifications are also within the scope of the present invention.

For example, even when the control unit 40 derives infrared light components and yellow (Ye), cyan (Cy) and magenta (Mg) as complementary light components from the image pickup device 30, conversion of the CMY space into the RGB space can make it possible to use the above-described detection processing.

In the third embodiment and the fourth embodiment, the partial subtraction component Sub_b of the B signal and the partial subtraction component Sub_r of the R signal are used to detect the human skin. However, the partial subtraction component Sub_g of the G signal and the partial subtraction component Sub_r of the R signal may be used instead for the same purpose. This is possible because the skin color has relatively close values for the B signal and the G signal.

In the third embodiment and the fourth embodiment, the partial subtraction components of the three kinds of signals, the R signal, the G signal and the B signal, are all calculated. However, it is not always necessary to calculate the Sub_g of the G signal, since, as mentioned above, the human skin can be detected by the use of he partial subtraction component Sub_b of the B signal and the partial subtraction component Sub_r of the R signal. Hence, it is also not necessary to calculate the average G signal Gavg and the ratio Tg, which are otherwise calculated in the preceding stage of the process.

Furthermore, the R signal, the G signal, the B signal and the IR signal which the control unit 40 uses for the detection processings in the foregoing embodiments may be ones generated as signals for the same frame from the same CCD or CMOS sensor. In this case, noise with dynamic bodies, that is, shifts in motion or angle of view, can be reduced, with the result of an enhanced detection accuracy. It goes without saying, however, that the R signal, the G signal and the B signal may be obtained from a frame other than that for the IR signal or that the elements which generate the R signal, the G signal and the B signal may be provided separately from those which generate the IR signal.

Furthermore, in the foregoing embodiments, the human skin is assumed as the target object. However, it is possible to assume a variety of objects as the target object. For example, when the leaves of trees are chosen as the target object, the pixel regions coming out as a result of subtraction of the partial subtraction component Sub_b of the B signal from the partial subtraction component Sub_r of the R signal in the third embodiment are the regions representing the leaves of trees.

While the preferred embodiments of the present invention have been described using specific terms, such description is for illustrative purposes only, and it is to be understood that changes and variations may be further made without departing from the spirit or scope of the appended claims.

What is claimed is:

1. A target detection apparatus for detecting a target object from within a picked-up image, wherein said apparatus detects the target object from within the image by utilizing reflection characteristics in both a visible light range and an infrared light range of the target object.

2. A target detection apparatus for detecting a target object from within a picked-up image, the apparatus including:
an image pickup device which outputs a plurality of different color components and an infrared light component from incident light; and
a control unit which generates hue components for respective regions from the plurality of color components and which determines whether the regions represent a target object or not by using the hue components and the infrared light component in the regions.

3. A target detection apparatus for detecting a target object from within a picked-up image, the apparatus including:
an image pickup device which outputs a plurality of different color components and an infrared light component from incident light; and
a control unit which performs a predetermined computation between each of at least two kinds of color components and an infrared light component and which determines whether a region corresponding to the computed components represents a target object by referring to the computation result.

4. A target detection apparatus according to claim 3, wherein said control unit computes a ratio between the color component and the infrared component.

5. A target detection apparatus according to claim 3, wherein said control unit computes a difference between the color component and the infrared component.

6. A target detection apparatus according to claim 3, wherein said control unit performs a plurality of different computations between each of at least two color components and an infrared light component and determines that the region corresponding to the computed components is a region representing the target object if each of results of all the computations fall within each of ranges of respective preset values.

7. A target detection apparatus according to claim 3, wherein said image pickup device outputs a red component, a green component and a blue component from entering light, and
wherein said control unit calculates a red subtraction value, which is obtained by subtracting a value of the red component multiplied by a predetermined coefficient from the infrared light component, a green subtraction value, which is obtained by subtracting a value of the green component multiplied by a predetermined coefficient from the infrared light component, and a blue subtraction value, which is obtained by subtracting a value of the blue component multiplied by a predetermined coefficient from the infrared light component, and determines whether the pixel represents a target object or not, using two values out of the red subtraction value, the green subtraction value and the blue subtraction value, or the difference therebetween.

8. A method for detecting a target object from within a picked-up image, wherein the target object is detected from within the picked-up image by utilizing reflection characteristics in both a visible light range and an infrared light range of the target object.
